(19) United States
(12) Patent Application Publication
(10) Pub. No.: US 2008/0021780 A1
(43) Pub. Date: Jan. 24, 2008

(54) INTRA-ORGANIZATION NEGOTIABLE INSTRUMENT PRODUCTION AND MESSAGING

(75) Inventor: Kenneth Algiene, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/830,701

(22) Filed: Jul. 30, 2007

Related U.S. Application Data
(62) Division of application No. 10/163,188, filed on Jun. 4, 2002.

(51) Int. Cl. G06Q 30/00

(52) U.S. Cl. 705/14

(57) ABSTRACT

Systems and methods for creating a negotiable instrument in combination with a message at a recipient point-of-contact. The systems and methods include a negotiable instrument printer located at the recipient point-of-contact. Access to the negotiable instrument printer is provided via an authorization system that in part prevents fraudulent use of the negotiable instrument printer.

### CROSS REFERENCE TO RELATED APPLICATIONS

The present application is related to U.S. patent application Ser. No. 09/737,912, entitled “Online Method and System for Ordering and Having Delivered a Paper Greeting Message and Payment System”, filed on Dec. 15, 2000, and assigned to the assignee of the present invention. The aforementioned Patent Application is incorporated herein by reference for all purposes. Similarly, the entirety of PCT Application No. 01/48609 of the same title is incorporated herein by reference for all purposes.

### BACKGROUND OF THE INVENTION

The present invention relates generally to the creation of negotiable instruments, and in particular to the creation of negotiable instruments and associated messages at a point-of-contact.

It is often desirable to provide a financial or other reward to associates. Thus, for example, a company may desire to reward particularly productive employees with a financial gift to further encourage the employee to continue their good work. Providing such incentives can involve indicating an amount to a third party payroll provider, that in turn is included in the employee's paycheck. Such an approach can involve considerable delay that can minimize the incentive effect of the payment.

Further, the employee may not fully understand why such a payment was provided. In such cases, the incentive effect is again reduced. To overcome this, some companies inform the employee of why the incentive is being paid. However, this again limits the incentive effect by separating the reason from the reward. Hence, for these and other reasons, there exists a need in the art to provide more efficient and/or effective systems and methods for creating and distributing incentive payments.

### BRIEF SUMMARY OF THE INVENTION

Various embodiments of the present invention include systems and methods for requesting and receiving incentive messages at a recipient point-of-contact. Such incentive messages can then be distributed to recipients associated with the recipient point-of-contact. Thus, the present invention provides an ability for a recipient point-of-contact to distribute incentives directly to recipients associated therewith. This can be efficient in terms of cost, time and effect.

One embodiment of the present invention provides a system for enabling point-of-contact preparation of incentive messages. The system includes a negotiable instrument printer located at the recipient point-of-contact and an authorization system communicably coupled to the printer. The authorization system includes a computer readable medium with computer instructions executable by the authorization system to: authorize requests to create incentive messages, and enable the printer to print a requested incentive message. In some cases, the printer includes a MICR printing capability that is enabled via the authorization system.

Other embodiments of the present invention provide methods for enabling point-of-contact preparation of incentive messages. In one particular instance, the method includes providing a negotiable instrument printer at a recipient point-of-contact, receiving a request for an incentive message via a communication network, and issuing a command to the negotiable instrument printer to create the incentive message at the recipient point-of-contact. The incentive message identifies an associate of the recipient point-of-contact. Some instances of the method further include authorizing the request for the incentive message and/or authenticating a requestor requesting the incentive message. Such authorization can include identifying a source of funds, assuring that sufficient funds are available from the source of funds, and/or requesting funds associated with the incentive message from the source of funds.

In some instances, the incentive message includes a negotiable instrument with a message associated therewith. Further, some instances include a message associated with the incentive message. Such a message can include, but is not limited to, a message from a manager of an intended recipient of the incentive message; an employee evaluation associated with an intended recipient of the incentive message; an occasion specific message; and/or a congratulatory greeting. In some cases, the incentive message includes a message and a negotiable instrument printed on the same document, while in other cases, the message and negotiable instrument are printed on separate documents that are associated before distribution to the intended recipient.

Another embodiment of the present invention provides a method for preparing one or more incentive messages at a recipient point-of-contact. Such a method includes providing a rule set that at least partially controls the creation of an incentive message, and communicating a request for the incentive message to an authorization system via a communication network. The method further includes receiving a response to the request at a negotiable instrument printer. The response enables the negotiable instrument printer to print the incentive message, which is then distributed to an associate of the recipient point-of-contact.

In some instances, the method further includes providing the rule set to the authorization system. In such cases, communicating the request for the incentive message includes communicating information about an associate of the recipient point-of-contact to the authorization system where the authorization system applies the rule set to the information. In other cases, the rule set is applied by the recipient point-of-contact to information about one or more associates of the recipient point-of-contact to determine which, if any incentive messages are to be distributed to the associates.

The summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates an incentive message system in accordance with embodiments of the present invention;

FIGS. 2-4 illustrate various methods for using the incentive message system of FIG. 1 in accordance with embodiments of the present invention; and

FIG. 5 is an example of an incentive message.

### DETAILED DESCRIPTION OF THE INVENTION

The present invention provides systems and methods for requesting and receiving incentive messages at a recipient point-of-contact. Such incentive messages can then be distributed to recipients associated with the recipient point-of-contact. Thus, the present invention provides an ability for a recipient point-of-contact to distribute incentives directly to recipients associated therewith. This can be efficient in terms of cost, time, and effect. To allow this, embodiments of the present invention also address security issues inherent in creating negotiable instruments at an unsecured location.

For the purposes of this document, an incentive message can be any negotiable instrument that is associated with a textual and/or a graphical message. Such negotiable instruments can be any instrument having an exchange value. For example, negotiable instruments can include, but are not limited to, checks, money orders, vouchers for plane tickets or other merchandise, checks payable to the order of a third party, gift certificates, coupons redeemable for frequent flyer miles or cellular phone minutes, and the like. Messages associated with the negotiable instruments can include, but are not limited to, special occasion greetings, congratulatory messages, get well messages, a manager's review of a particular employee, or the like. The messages can be textual, graphical, or a combination thereof. Thus, for example, a message can include a logo associated with the recipient point-of-contact. Based on this discussion, one of ordinary skill in the art will recognize a number of other message types and/or negotiable instruments that can be combined to create an incentive message in accordance with the present invention.

Also for purposes of this document, a recipient point-of-contact can be any entity desiring to distribute messages to one or more recipients associated therewith. Thus, a recipient point-of-contact can be an employer with a number of recipient employees. As another example, a recipient point-of-contact can be a company desiring to distribute incentive messages to one or more recipient clients. As will be appreciated, a recipient is any person or entity enjoying some relationship and/or association with a recipient point-of-contact. Thus, for example, a recipient can be an employee, a charitable donor, a client, a customer, or any other associate of the recipient point-of-contact. Based on this discussion, one of ordinary skill in the art will recognize a number of other examples of a recipient point-of-contact and/or recipients that are possible in accordance with the present invention.

As a specific example, the present invention provides systems and methods that allow a requester, such as a human resources manager for a recipient point-of-contact, to request incentive messages for all recipient employees that have worked for the recipient point-of-contact for five years. The requested incentive messages are authorized by a central authorization system, and a message is sent to a printer located at the recipient point-of-contact that enables the printer to print negotiable instruments that are combined with a congratulatory message noting the five years of service. From this point, the incentive messages can be distributed within the organization of the recipient point-of-contact to the various employee recipients. Thus, the present invention provides a quick and efficient mechanism for encouraging and/or rewarding employees of the recipient point-of-contact. The following discussion provides greater detail about the systems and methods associated with the present invention. From such discussion, one of ordinary skill in the art will recognize the myriad of possible applications for the present invention in addition to the previously recited specific example.

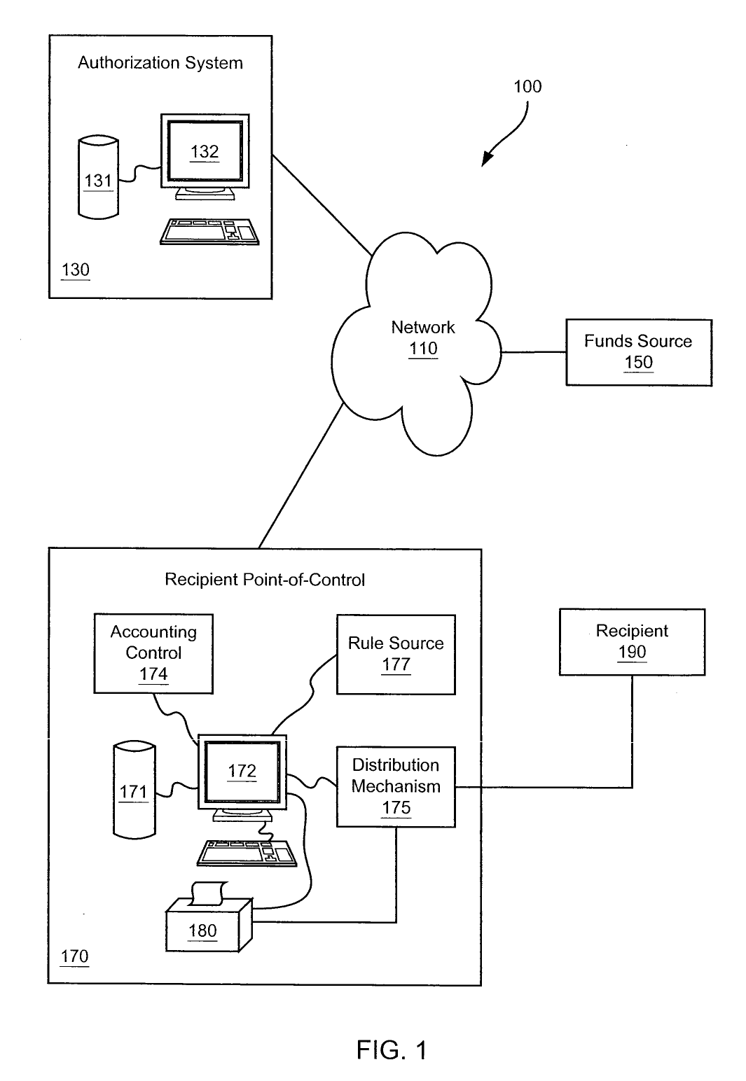

Referring to FIG. 1, an incentive message system 100 in accordance with an embodiment of the present invention is illustrated. Incentive message system 100 includes an authorization system 130, a recipient point-of-contact 170, and a funds source 150 all communicably coupled via a communication network 110. Communication network 110 can be any communication network capable of providing communications between the various elements of incentive message system 100. In some embodiments, communication network 110 is the Internet providing message based communication between any of recipient point-of-contact 170, funds source 150, and/or authorization system 130. In other embodiments, communication network 110 comprises a TCP/IP compliant virtual private network (VPN). In yet other embodiments, communication network 110 includes the Internet for communication between recipient point-of-contact 170 and authorization system 130, and a VPN between authorization system 130 and funds source 150. However, it should be recognized that other communication networks could be used to provide similar functionality. For example, communication network 110 can be a local area network (LAN), a wide area network (WAN), a telephone network, a cellular telephone network, a virtual private network (VPN), the Internet, an optical network, a wireless network, or any other similar communication network or combination thereof.

Funds source 150 can be any source of funds used to cover an amount indicated by the negotiable instruments of the incentive messages and/or transaction fees related to creating the incentive messages. Thus, for example, funds source 150 can be a credit account, a credit card company, a bank, a company providing cellular minutes, frequent flyer miles and/or merchandise, or the like. Further, in some embodiments, funds source is two distinct entities where one of the entities provides funds to pay transaction fees and the other entity provides merchandise designated by the negotiable instrument provided with an incentive message. Thus, for example, creation of an incentive message may include a transaction fee of a nickel and include a negotiable instrument good for a turkey at a local supermarket chain. In such a case, funds source 150 can include a bank associated with recipient point-of-contact 170 to pay the transaction fee, and the local supermarket to cover the negotiable instrument, where the local supermarket enjoys a separate contractual arrangement with recipient point-of-contact 170. Alternatively, funds source 150 can be just the bank providing funds to cover both transaction fee and the merchandise. In such a case, authorization system 130 can be responsible for transferring funds from the bank to the local supermarket to cover the merchandise indicated by the negotiable instrument.

As an alternative example, creation of an incentive message may include the same transaction fee, but include a money order drawn on an entity maintaining authorization system 130. In such a case, funds source 150 can include a bank associated with recipient point-of-contact 170 that provides funds sufficient to cover the money order and the transaction fees. Authorization system 130 transfers funds from the bank to cover both the transaction fees and the money order, and in turn authorizes printing and distribution of an incentive message including the money order.

As previously suggested, authorization system 130 provides a central control function of incentive message system 100. Authorization system 130 includes a database 131 and a computer 132 for providing such control. Database 131 includes information about relationships with various recipient point-of-contacts 170 and/or funds sources 150. Computer 132 can be any microprocessor based device capable of initiating and/or receiving communications via communication network 110, responding to requests from recipient point-of-contact 170, and interacting with funds source 150. In one particular embodiment, computer 132 is a group of computers including a network server, and a database server.

Recipient point-of-contact 170 includes a computer 172, a database 171, a rule source 173, an accounting control 174, a distribution mechanism 175, and a negotiable instrument printer 180. Database 171 can be any database capable of maintaining information about one or more potential recipients. Thus, database 171 can include, but is not limited to, information about employees, donors, customers, clients, or other associates of recipient point-of-contact 170. Such information can include date of birth, employment anniversary dates, milestones such as amount of sales, performance review statistics, or any other information that can be used as the basis of providing an incentive message to the potential recipient.

Computer 172 can be any computer capable of communicating with authorization system 130 via communication network 10, receiving and/or accessing information related to incentive messages, and communicating with negotiable instrument printer 180. In one embodiment, computer 172 is a personal computer (PC), while in other embodiments, computer 172 is a combination of a database server and a personal computer. It should be recognized that any computer, or combination of computers can be used in accordance with the present invention. Thus, computer 172 can include a PC, a network server, laptop computer, a network server, a personal digital assistant (PDA), any combination thereof, or the like.

Accounting control 174 includes systems responsible for accounting for the various transaction fees and costs of negotiable instruments associated with incentive messages that are created. Further, in some cases, accounting control 174 is responsible for transferring funds to funds source 150 to cover creation of incentive messages. As such, accounting control 174 can include a computer and software running thereon to provide such functionality. Alternatively, accounting control 174 can include software running on computer 172. Rule source 173 includes systems responsible for defining and/or executing rules that govern the creation and distribution of incentive messages. In one embodiment, rule source 173 is a computer and a database of parameters that, for example, initiate the creation of an incentive message for all employees of recipient point-of-contact 170 that have achieved a set performance criteria. In some cases, creation of incentive messages is performed automatically under the control of rule source 173. In other embodiments, rule source 173 merely provides an indication of incentive messages that could possibly be created, and a person using computer 172 actually requests creation of one or more of the indicated incentive messages. In particular embodiments, rule source 173 is implemented as part of authorization system 130, while in the illustrated embodiment, it is implemented as part of recipient point-of-contact 170.

Distribution mechanism 175 includes systems responsible for distributing incentive messages to recipients 190. As such, distribution mechanism 175 can include an interoffice mail system associated with recipient point-of-contact 170, or simply a person that finds the recipients and delivers the incentive messages. Alternatively, distribution mechanism 175 can include an email system that informs one or more recipients that an incentive message is available for them to pick up at some central or other location. In accordance with the present invention, many other distribution systems are of course possible.

Negotiable instrument printer 180 can be any secure printer capable of receiving instructions for printing financial instruments, or other negotiable instruments as previously defined, and executing the instructions by printing the desired negotiable instruments. The negotiable instruments are printed by negotiable instrument printer 180 on plain paper, or other paper that does not have any intrinsic value. Such paper cannot be used to fraudulently create financial instruments, absent authorized access to printer 180. As such, the paper need not be accounted for and secure storage of the paper is not necessary.

Further, negotiable instrument printer 180 can include a number of security features including user and device authentication to minimize any threat that negotiable instrument printer 180 can be used to fraudulently print financial instruments. For the purposes of this document, authentication is a process whereby a person or entity accessing incentive message system 100, or elements thereof, are identified and checked to assure that the access they are requesting is authorized. Thus, for example, if negotiable instrument printer 180 were stolen, it would be of little value because authorization to print financial instruments would not be granted absent an authentication of the person or entity requesting access. Similarly, for the purposes of this document, authorization is a process whereby an action requested by an authenticated requester is either granted or denied. Thus, for example, if an authenticated requester requests an incentive message with a negotiable instrument for an amount in excess of a set limit, the request may not be authorized. Negotiable instrument printer 180 can include a laser printer, or other printer capability, that when properly authorized is capable of printing using a magnetic ink character recognition (MICR) font. The MICR font is used to place encoded characters on each of the negotiable instruments based on a standard as prescribed by the American Banking Association. Such fonts can be read by magnetic character recognition systems used by a financial, or other institution redeeming the negotiable instrument.

Negotiable instrument printer 180 can include a variety of security features to enable the secure operation of the integrated system. For example, negotiable instrument printer 180 can include bi-directional communication capabilities that are used to request, receive and authenticate a password from an external source prior to accessing the MICR font to create a negotiable instrument. This bi-directional communication further allows the printer to communicate error codes created during the printing process to allow for auditing of potential problems with printed instruments. Further, in some instances, the MICR font is rendered inaccessible where negotiable instrument printer is disconnected from a known network connection location. Thus, absent the re-enablement of negotiable instrument printer 180 according to one or more authentication procedures, negotiable instrument printer cannot be stolen and subsequently used to create fraudulent financial instruments.

In various cases, beyond limiting access to a MICR font, access to any functionality of negotiable instrument printer 180 can be denied absent appropriate authorization and/or authentication. Alternatively, printing of particular logos used to authenticate a negotiable instrument can be prohibited by negotiable instrument printer 180 absent the appropriate authorization.

One example of such a printer is disclosed in U.S. Pat. No. 6,088,684 (“the '684 patent”), entitled “Secure Printer For Printing Financial Instruments”, by Custy et al., and assigned to the assignee of the present application. The entirety of the '684 patent is incorporated herein by reference for all purposes. Similarly, the entirety of U.S. Pat. No. 5,774,879, (the '879 patent), entitled “Automated Financial Instrument Processing System”, by Custy et al., and assigned to the assignee of the present application is also incorporated herein by reference for all purposes.

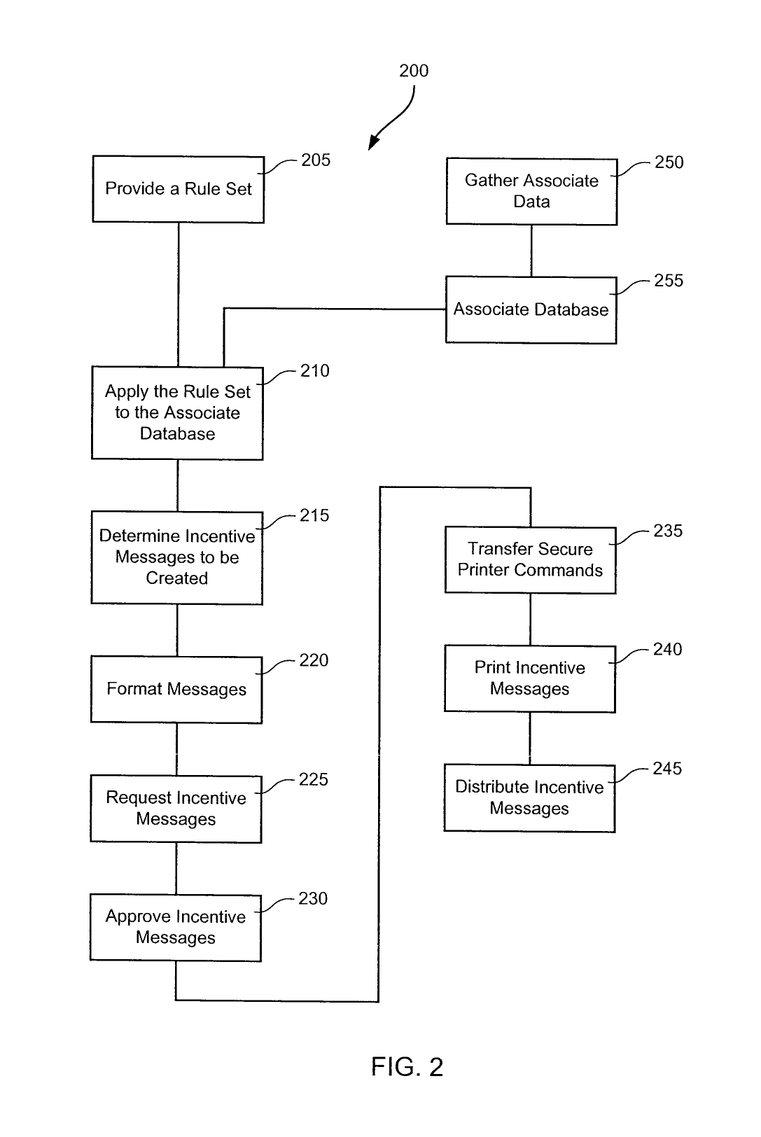

Referring to FIG. 2, a flow diagram 200 illustrates a method in accordance with one embodiment of the present invention for using incentive message system 100. Following flow diagram 200, a rule set governing the creation and distribution of incentive messages is provided (block 205). Providing the rule set can include defining the rules, and in some cases, formatting the rule set into a computer program whereby the rules can be automatically applied to information associated with one or more potential recipients to determine which, if any of the potential recipients will be provided with an incentive message. Many examples of rule sets are possible in accordance with the present invention.

For example, a rule set may indicate that all customers of recipient point-of-contact 170 that purchased more than a set amount of goods or services will be provided with an incentive message of a particular value and with a particular message. As another example, a rule set may indicate that all employees of recipient point-of-contact 170 that have been employed continuously for five years will be provided with an incentive message with a value and a message appropriate to the milestone. As yet another example, a rule set may indicate that all employees of recipient point-of-contact 170 are to be given an incentive message with a message from the employees manager and a negotiable instrument in an amount commensurate with a performance review of the employee provided by the same manager. In one particularly simple embodiment, the rule set is maintained in the mind of an executive of recipient point-of-contact 170, and represents a biased opinion of about which recipients the executive desires to provide an incentive message. Based on this, one of ordinary skill in the art will recognize the many different rules and combinations of rules that can be implemented in accordance with the present invention.

Information about the potential recipients is gathered (block 250) and stored to database 171 (block 255). Information from database 171 is accessed, and the provided rule set (block 205) is applied to the information (block 210). In some embodiments, this application is performed by a software program providing the functionality of rule source 173 and executed by computer 172. The results of the execution can then be reviewed prior to requesting incentive messages, or automatically used to request incentive messages without any further review. In other embodiments, application of the rule set to the information is manual where, for example, a human resource's employee of recipient point-of-contact 170 reviews the information and identifies recipients that meet one or more criteria defined by the rule set.

From application of the rule set to the information about the potential recipients (block 210) it is determined which of the potential recipients are to receive incentive messages (block 215). In addition, one or more messages to be associated with the incentive messages are formatted (block 220). This formatting can include selecting a canned message appropriate to the recipient, providing a custom message, formatting a portion of a recipient's performance review for inclusion with an incentive message, and the like. As previously mentioned, the message can be any textual and/or graphical message that is to be associated with a negotiable instrument.

Next, an incentive message is requested (block 225). Such a request is provided by computer 172 to authorization system 130 via communication network 110. Further, such requests can include an indication of the type of negotiable instrument desired, an amount of the negotiable instrument, and a message to be printed along with the negotiable instrument. In one particular embodiment where only money orders are provided, the request includes an amount of the money order, and the message to be printed with the money order. In some embodiments, as part of sending the incentive message request, a requestor is authenticated. This can include requesting and verifying a requestor's password and login name, or in cases where the incentive messages are automatically requested, authentication can include a handshake of security codes between computer 172 and authorization system 130 to avoid any potential fraud.

Upon receiving the request(s) for an incentive message(s), authorization system 130 proceeds to authorize the requested incentive messages (block 220). This authorization can include a variety of procedures. For example, in one embodiment where the requested incentive messages include money orders drawn on the entity maintaining authorization system 130, authorization can include querying funds source 150 to assure sufficient funds exist to cover the money orders. In other embodiments, authorization further includes requesting the funds to cover the money orders from funds source 150. In yet other embodiments, authorization is not granted until the funds are actually received from funds source 150 by an entity maintaining authorization system 130.

In other instances where the incentive messages include negotiable instruments drawn on a third party, such as a bank or source of merchandise, authorization can include obtaining permission to issue such negotiable instruments on behalf of the third party. For example, in embodiments where the negotiable instrument is a certificate for frequent flyer miles, authorization system 130 can contact the airline redeeming the frequent flyer miles and request permission. Where recipient point-of-contact has a relationship with the airline to pay for any provided miles, the airline may grant the necessary permission and provide a confirmation code to authorization system 130. Based on this confirmation code, authorization system 130 proceeds to authorize the incentive message request.

With the incentive message request authorized, authorization system 130 communicates commands to recipient point-of-contact 170 to enable printing of the requested incentive messages including the negotiable instruments (block 235). Such secure commands can be commands to enable the MICR printing capability of negotiable instrument printer 180, or the printing of secure logo or other indicators by negotiable instrument printer 180.

After being enabled, negotiable instrument printer 180 proceeds to print the requested incentive messages (block 240). This can include printing both the negotiable instrument and the message on a single document, or printing the negotiable instrument and message on separate documents. The incentive messages are then distributed to the indicated recipients 190 using distribution mechanism 175 (block 245).

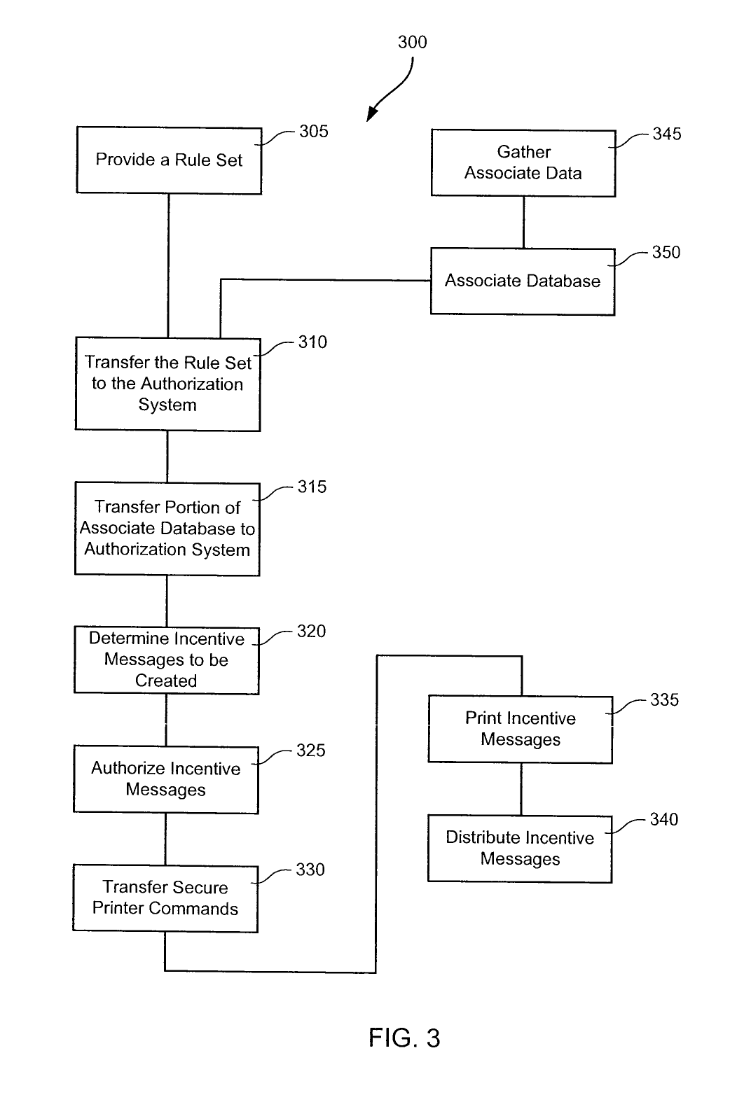

Referring to FIG. 3, a flow diagram 300 illustrates a method in accordance with another embodiment of the present invention for using incentive message system 100. Following flow diagram 300, a rule set governing the creation and distribution of incentive messages is provided (block 305). The provided rule set (block 305) is then transferred to authorization system 130 (block 310). As with the previous flow diagram, information about potential recipients is gathered (block 345) and stored to database 171 (block 350). A portion of database 171 relevant to creating incentive messages is transferred to authorization system 130 (block 315). In some embodiments, the portion of database 171 that is transferred includes fields that trigger one or more rules in the transferred rule set, and if desired, a customized message to be associated with an incentive message provided when the rules are satisfied for a particular recipient.

Upon receiving the information from database 171 (block 315), computer 132 of authorization system 130 applies the received rule set (block 310) to the information from database 171 to determine which, if any of the potential recipients are to receive incentive messages, and what type of incentive messages are to be received (block 320). Where the transferred information includes data indicating that one or more potential recipients have satisfied criteria for receiving an incentive message, the various incentive messages are assembled and the total cost for all incentive messages is calculated. Said another way, a request for an incentive message can be performed by providing a data set to authorization system 130, where authorization system 130 in turn determines what incentive messages to create according to the rule set.

Thus, for example, the rule set may indicate that an incentive message is to be sent on a recipient's birthday, and that the incentive message is to include a money order for ten dollars along with the message “happy birthday”. The portion of database 171 that is transferred to authorization system 130 includes a list of birth dates for the potential recipients. Thus, a potential recipient with an appropriate birth date will automatically be provided with the aforementioned incentive message. Alternatively, the portion of database 171 that is transferred to authorization system 130 may include the custom message “happy birthday you old man”. Where this custom message is provided, it is used to override the default message provided with the rule set. Thus, the recipient would received the aforementioned incentive message, but with the message “happy birthday you old man” in place of the default message “happy birthday”.

In addition, authorization system 130 authorizes the incentive messages (block 325). As with the previous method, this authorization can include determining if sufficient funds and/or credit exists to cover the requested incentive message(s). With the incentive message(s) authorized, authorization system 130 communicates commands to recipient point-of-contact 170 to enable printing of the requested incentive messages including the negotiable instruments (block 330). After being enabled, negotiable instrument printer 180 proceeds to print the requested incentive messages (block 335), and the incentive messages are distributed to the indicated recipients 190 using distribution mechanism 175 (block 340).

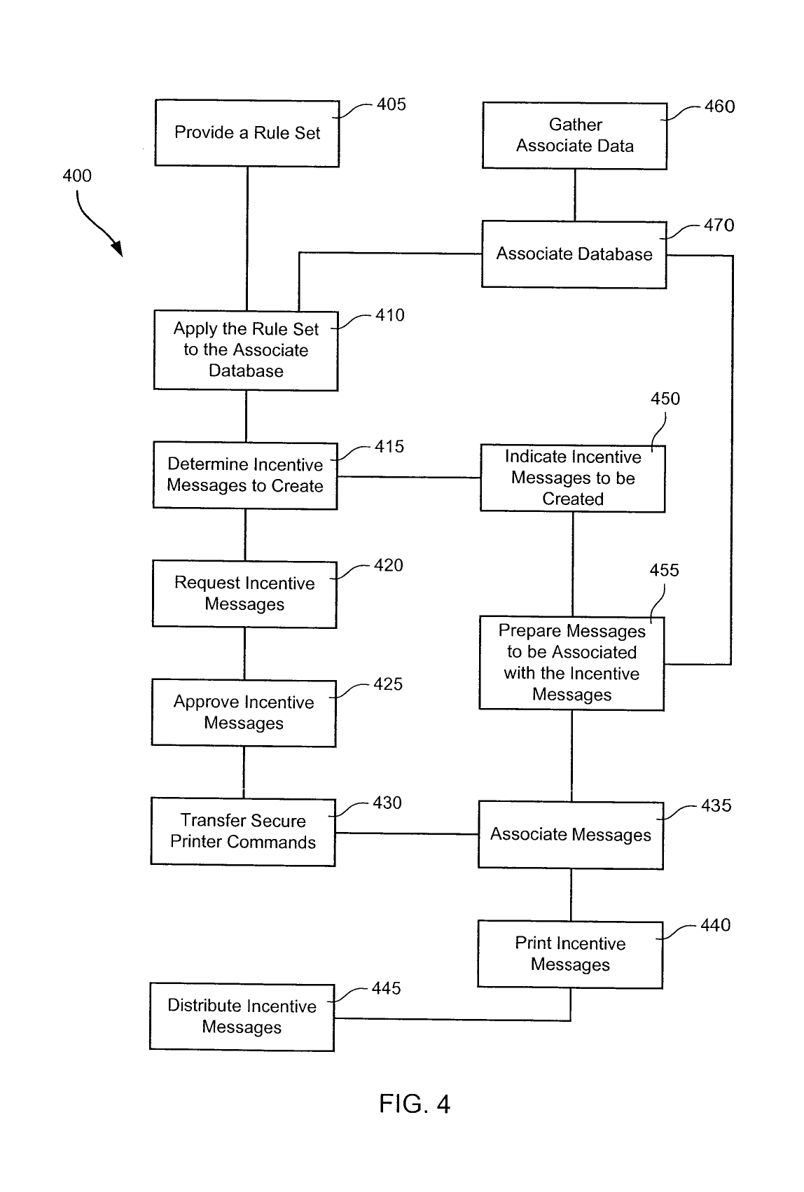

Referring to FIG. 4, a flow diagram 400 illustrates a method in accordance with yet another embodiment of the present invention for using incentive message system 100. In this embodiment, the message is disassociated from the negotiable instrument until the incentive message is printed. In this way, authorization system 130 participates in the creation of the negotiable instrument, but can be shielded from the message, and even the identity of the recipient that receives the incentive message. This helps maintain the privacy of recipient point-of-contact 170.

Following flow diagram 400, a rule set governing the creation and distribution of incentive messages is provided (block 405). In addition, information about the potential recipients is gathered (block 460) and stored to database 171 (block 470). Information from database 171 is accessed, and the provided rule set (block 405) is applied to the information (block 410). As previously described the incentive messages to be created are determined from the application of the rule set to the information from database 171 (block 415).

Next, incentive messages are requested to satisfy those determined by application of the rules set to the information (block 420). Authorization system 130 receives the requests and authorizes the incentive messages as previously discussed (block 425). With the incentive message(s) authorized, authorization system 130 communicates commands to recipient point-of-contact 170 to enable printing of the requested incentive messages including the negotiable instruments (block 430).

Also, upon determining which incentive messages to request (block 415), an indication that a message is to be sent is provided to computer 172 (the same computer 172 also may have determined which messages to send) (block 450). Based on this indication, computer 172 accesses database 171 to determine the message to be associated with the determined incentive messages (block 455). As previously discussed, such a message can be a canned message or a customized message maintained in database 171, or keyed in via computer 172.

The prepared message is associated with the command from authorization system 130 to print the negotiable instrument (block 435). This association can result in a single group of printer commands that, when applied to negotiable instrument printer 180, cause the desired incentive message to be printed. Upon receiving the print command, negotiable instrument printer 180 proceeds to print the requested incentive messages (block 440), and the incentive messages are distributed to the indicated recipients 190 using distribution mechanism 175 (block 445).

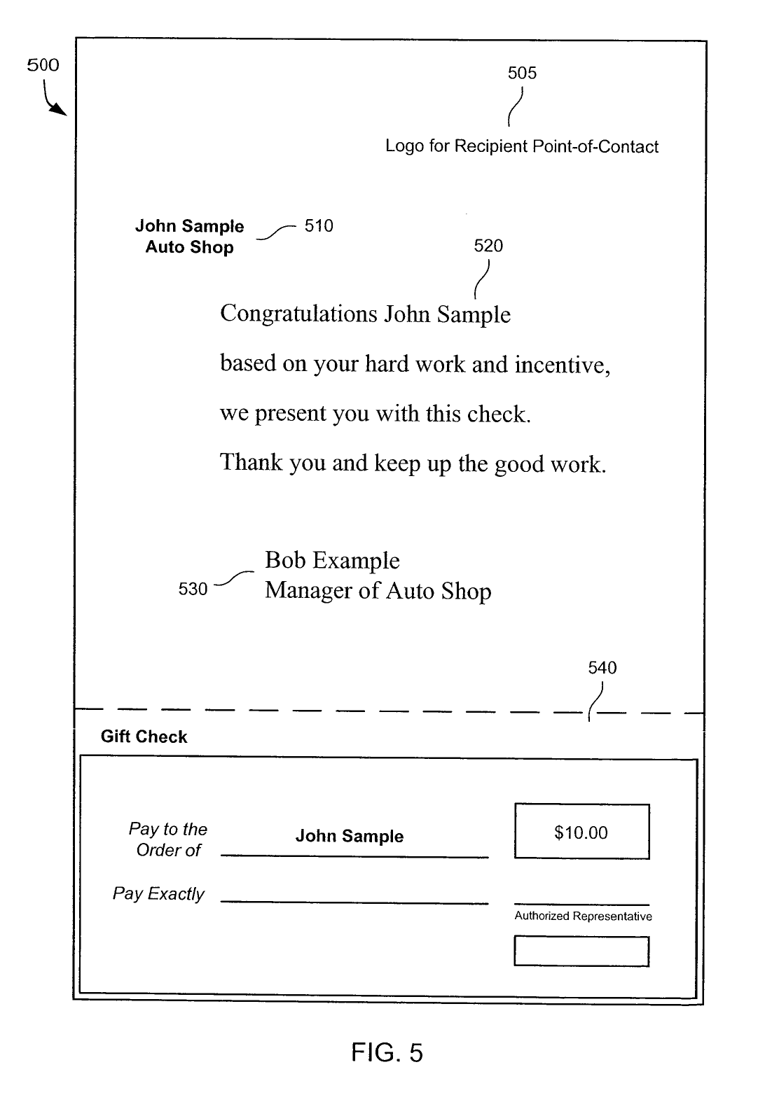

FIG. 5 illustrates an example of an incentive message 500. Incentive message 500 includes a message 550 and a negotiable instrument 540. As illustrated, message 550 includes a logo 505 of recipient point-of-contact 170, a location 510 of recipient 190 (in this case John Sample), a congratulatory message 520, and a source of the message 530 (in this case Bob Example). Of note, the source of the message 530, and the requester of the incentive message need not be the same.

Various examples of systems and methods for requesting a message associated with a negotiable instrument are provided in U.S. patent application Ser. No. 09/737,912, entitled “Online Method and System for Ordering and Having Delivered a Paper Greeting Message and Payment Instrument”, and assigned to the assignee of the present application. The entirety of the aforementioned application was previously incorporated herein by reference for all purposes.

In one particular embodiment, the present invention further includes a process whereby a representative of recipient point-of-contact 170 contacts a representative of authorization system 130 by telephone, or other means of communication, and indicates the type of incentive message that is desired. Based on this, the desired incentive message is designed and transferred to recipient point-of-contact 170 for approval and use. Alternatively or in addition, various online design tools can be provided by authorization system 130. These tools can be accessed by representatives of recipient point-of-contact 170 and used to design custom incentive messages for use as previously discussed.

In addition, the present invention can be used in relation to various systems and/or methods disclosed in U.S. patent application Ser. No. 09/416,518, entitled “Electronic Payroll System and Method”, filed on Oct. 8, 1999, and assigned to the assignee of the present invention. The entirety of the aforementioned patent application is incorporated herein by reference for all purposes. As one example, an incentive message can include a message indicating to which electronic account associated with the recipient that a deposit was directed, as well as, a congratulatory message and/or a negotiable instrument. As yet a further refinement, the account associated with the recipient can be a stored value account.

The invention has now been described in detail for purposes of clarity and understanding. However, it will be appreciated that certain changes and modifications may be practiced within the scope of the appended claims. For example, more than one negotiable instrument may be associated with a given incentive message, or messages from one or more sources may be combined on a single incentive message. Further, a request for two or more incentive messages designating the same recipient can be aggregated such that a single incentive message for the recipient is created. Yet further, payment by recipient point-of-contact 170 to authorization system 130 can be accomplished by any number of means including payment by check or credit card. In addition, any event can trigger the production and distribution of an incentive message including a birthday, an anniversary, a milestone, or any other type of event. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

1. A system for enabling point-of-contact preparation of incentive messages, the system comprising:
a negotiable instrument printer, wherein the negotiable instrument printer is located at a recipient point-of-contact;
an authorization system, wherein the authorization system comprises a computer readable medium and is communicably coupled with the negotiable instrument printer; and
wherein the computer readable medium comprises computer instructions executable by the authorization system to:
authorize a request to print an incentive message, wherein the request is received from a requestor associated with the recipient point-of-contact; and
enable the negotiable instrument printer to print the incentive message, wherein the incentive message identifies a recipient associated with the recipient point-of-contact.

2. The system of claim 1, wherein the negotiable instrument printer comprises a MICR printing capability, and wherein enabling the negotiable instrument printer to print the incentive message comprises enabling access to the MICR printing capability.

3. A method for enabling point-of-contact preparation of incentive messages, the method comprising:
providing a negotiable instrument printer at a recipient point-of-contact;
receiving a request for an incentive message via a communication network; and
issuing a command to the negotiable instrument printer, wherein the command causes the negotiable instrument printer to create the incentive message at the recipient point-of-contact, and wherein the incentive message identifies an associate of the recipient point-of-contact.

4. The method of claim 3, the method further comprising:
authorizing the request for the incentive message.

5. The method of claim 4, wherein authorizing the request for the incentive message further comprises authenticating a requestor requesting the incentive message.

6. The method of claim 4, wherein authorizing the request for the incentive message includes identifying a source of funds and assuring that sufficient funds are available from the source of funds.

7. The method of claim 6, the method further comprising:
requesting funds associated with the incentive message from the source of funds.

8. The method of claim 3, wherein the incentive message comprises a negotiable instrument with a message associated therewith.

9. The method of claim 3, the method further comprising:
receiving a rule set from the recipient point-of-contact, wherein receiving the request for the incentive message comprises receiving information about one or more associates of the recipient point-of-contact, and applying the rule set to the information about the one or more associates of the recipient point-of-contact.

10. The method of claim 3, wherein receiving the request for the incentive message comprises receiving a message to be associated with incentive message.

11. The method of claim 10, wherein the message is selected from a group consisting of: a message from a manager of an intended recipient of the incentive message; an employee evaluation associated with an intended recipient of the incentive message; an occasion specific message; and a congratulatory greeting.

12. The method of claim 3, wherein issuing a command to the negotiable instrument printer comprises sending a security code to enable a MICR printing capability of the negotiable instrument printer.

13. The method of claim 3, wherein creating the incentive message at the recipient point-of-contact comprises printing a message and a negotiable instrument on the same document.

14. The method of claim 3, wherein creating the incentive message at the recipient point-of-contact comprises printing a message and a negotiable instrument, wherein the message and the negotiable instrument are associated before being distributed to a recipient.

15-28. (canceled)
